(19) United States
(12) Patent Application Publication
(10) Pub. No.: US 2026/0154863 A1
(43) Pub. Date: Jun. 4, 2026

(54) AUTOMATED IMAGE ANALYSIS SYSTEM FOR RF MEASUREMENT DATA EXTRACTION

(71) Applicant: KEYSIGHT TECHNOLOGIES, INC., SANTA ROSA, CA (US)

(72) Inventor: Maxim Pletner, SANTA CLARA, CA (US)

(21) Appl. No.: 19/393,129

(22) Filed: Nov. 18, 2025

Related U.S. Application Data
(60) Provisional application No. 63/726,429, filed on Nov. 29, 2024.

(51) Int. Cl. G06T 11/00; G06T 11/20

(52) U.S. Cl. CPC G06T 11/10; G06T 11/26

(57) ABSTRACT

A system for automated image analysis and data extraction includes an image input module configured to receive a measurement screenshot, an image recognition module configured to detect header information, trace identifiers, and grid coordinates from the measurement screenshot, a data processing module configured to convert pixel coordinates to measurement values based on the detected header information and grid coordinates, an error correction module configured to calculate and apply error estimates to the converted measurement values, and an output module configured to generate formatted measurement data based on the error-corrected converted measurement values.

### CROSS-REFERENCE TO RELATED APPLICATION

The present application claims priority under 35 U.S.C. § 119 (e) to U.S. Provisional Application No. 63/726,429 filed on Nov. 29, 2024. The entire disclosure of U.S. Provisional Application No. 63/726,429 is specifically incorporated herein by reference in its entirety.

### FIELD OF INVENTION

The present disclosure relates to automated image analysis systems for extracting measurement data, and more particularly to an automated image analysis framework for extracting and processing radio frequency (RF) measurement data from graphical representations generated by electronic measurement instruments.

### BACKGROUND

Many test and measurement instruments, such as network analyzers and spectrum analyzers, allow users to save both raw data and measurement results. However, there is a lack of embedded and automated tools to recognize and process saved image data for further mathematical operations or overlaying with raw data traces. There are many online and paid tools available for simple one curve detection in images, but they are not specialized for RF measurement data and are not tailored for physical measurements. These general-purpose tools require significant input from engineers, such as manually detecting grids and specifying various scaling and grid legend parameters. Moreover, they often struggle to operate with multiple traces in a single image. As a result, the effort needed to convert data from screenshots is extensive, and the outcomes can be highly inaccurate. Engineers often need to recalculate results to ensure they have the correct units and measurement headers, making the entire process cumbersome and prone to errors. There is also no single environment that allows not only the conversion of data but also the addition of new data points for visual correlation studies with existing raw trace information, which is mostly in .csv (comma separated values) format.

### SUMMARY

According to an aspect of the inventive concepts, a system for automated image analysis and data extraction is provided. The system includes an image input module configured to receive a measurement screenshot, an image recognition module configured to detect header information, trace identifiers, and grid coordinates from the measurement screenshot, a data processing module configured to convert pixel coordinates to measurement values based on the detected header information and grid coordinates, an error correction module configured to calculate and apply error estimates to the converted measurement values, and an output module configured to generate formatted measurement data based on the error-corrected converted measurement values.

The image recognition module may further configured to detect multiple traces within the measurement screenshot, and the data processing module may further be configured to convert pixel coordinates to measurement values for each of the multiple detected traces.

The image recognition module utilizes a large language model (LLM) for detecting header information, trace identifiers, and grid coordinates. The LLM may be fine-tuned for recognizing specific graphical elements relevant to RF and measurement data.

The error correction module may be configured to calculate error estimates based on comparison with previously saved trace data for the same measurement setup. The error correction module may be further configured to apply standard power level accuracy from a vector network analyzer datasheet when no previously saved trace data is available.

According to another aspect of the inventive concepts, a method for automated image analysis and data extraction is provided. The method includes receiving a measurement screenshot, and then detecting, using image recognition techniques, header information, trace identifiers, and grid coordinates from the measurement screenshot. The method further includes converting pixel coordinates to measurement values based on the detected header information and grid coordinates, and calculating and applying error estimates to the converted measurement values. The method still further includes generating formatted measurement data based on the error-corrected converted measurement values.

The detection of header information, trace identifiers, and grid coordinates may include utilizing a large language model (LLM) fine-tuned for recognizing specific graphical elements relevant to RF and measurement data.

The method may further include modifying the measurement screenshot by recoloring traces and their associated information prior to detecting header information, trace identifiers, and grid coordinates.

Converting pixel coordinates to measurement values may include excluding pixel coordinates that fall outside the detected grid coordinates, and generating new coordinate pairs relative to the grid location. The method may further include assigning trace identifiers to the converted measurement values based on the detected trace identifiers.

Calculating error estimates may include comparing the converted measurement values to previously saved trace data for the same measurement setup. Generating formatted measurement data may include outputting the error-corrected converted measurement values in a CSV format and as a plot in measurement analytics software.

According to still another aspect of the inventive concepts, a non-transitory computer-readable medium storing instructions is provided that, when executed by a processor, cause the processor to perform operations for automated image analysis and data extraction, the operations including receiving a measurement screenshot, and detecting, using image recognition techniques, header information, trace identifiers, and grid coordinates from the measurement screenshot. The operations further including converting pixel coordinates to measurement values based on the detected header information and grid coordinates, calculating and applying error estimates to the converted measurement values, and generating formatted measurement data based on the error-corrected converted measurement values.

Detecting header information, trace identifiers, and grid coordinates may include utilizing a large language model (LLM) fine-tuned for recognizing specific graphical elements relevant to RF and measurement data.

The operations may further include modifying the measurement screenshot by recoloring traces and their associated information prior to detecting header information, trace identifiers, and grid coordinates.

Converting pixel coordinates to measurement values may include excluding pixel coordinates that fall outside the detected grid coordinates, and generating new coordinate pairs relative to the grid location.

The operations may further include assigning trace identifiers to the converted measurement values based on the detected trace identifiers.

Calculating error estimates may include comparing the converted measurement values to previously saved trace data for the same measurement setup, and generating formatted measurement data may include outputting the error-corrected converted measurement values in a CSV format and as a plot in measurement analytics software.

### BRIEF DESCRIPTION OF DRAWINGS

The above and other aspects and features of the inventive concepts will become readily apparent from the detailed description that follows, with reference to the accompanying drawings, in which:

FIG. 1 illustrates a flowchart for reference in describing the construction and operation of automated image analysis system according to embodiments of the inventive concepts;

FIG. 2 depicts a system diagram of an automated image analysis framework in accordance with example embodiments.

FIG. 3 shows a test plan interface for a demo AI curve test according to an embodiment of the inventive concepts;

FIG. 4 illustrates a user interface for configuring test step settings according to an embodiment of the inventive concepts;

FIG. 5 depicts a screenshot of a network analyzer display showing an S-parameter measurement according to an embodiment of the inventive concepts;

FIG. 6 shows a text-based display of measurement trace information according to an embodiment of the inventive concepts;

FIG. 7 illustrates a data table representing grid definitions for an image analysis system according to an embodiment of the inventive concepts;

FIG. 8 depicts a table containing pixel data for a trace extracted from an image according to an embodiment of the inventive concepts;

FIG. 9 shows a system for defining grid corners in an image analysis framework according to an embodiment of the inventive concepts;

FIG. 10 illustrates a text output from an image analysis process according to an embodiment of the inventive concepts;

FIG. 11 depicts a table representing coordinate data for a rectangular grid area according to an embodiment of the inventive concepts;

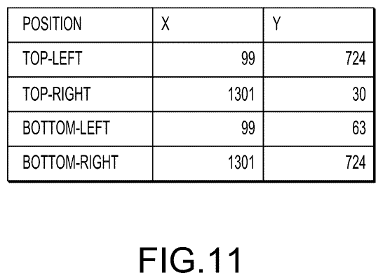

FIG. 12 shows a code snippet for processing grid and trace data according to an embodiment of the inventive concepts;

FIG. 13 illustrates a data table containing measurement results for a frequency response analysis according to an embodiment of the inventive concepts;

FIG. 14 depicts a graph showing measurement data from a network analyzer according to an embodiment of the inventive concepts;

FIG. 15 shows a graph comparing raw data and converted data from a measurement according to an embodiment of the inventive concepts;

FIG. 16 illustrates a flowchart for reference in describing an error correction process in an image analysis system according to an embodiment of the inventive concepts.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted to avoid obscuring the description of the example embodiments. Such methods and apparatuses are clearly within the scope of the present teachings. Further, throughout the drawings, like reference numbers refer to the same or similar elements.

The terminology used herein is for purposes of describing particular embodiments only, and is not intended to be limiting. The defined terms are in addition to the technical and scientific meanings of the defined terms as commonly understood and accepted in the technical field of the present teachings. As used in the specification and appended claims, the terms ‘a’, ‘an’ and ‘the’ include both singular and plural referents, unless the context clearly dictates otherwise. Thus, for example, ‘a device’ includes one device and plural devices. Further, for example, when one element is described as being “connected to” another element, the one element may be directly connected to the other element, or indirectly connected to the other element in an operative manner.

Separately, as is traditional in the field of the inventive concepts, example embodiments may be described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, in the absence of an indication to the contrary, the units and/or modules being implemented by microprocessors or similar may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the example embodiments. Conversely, the blocks, units and/or modules of the example embodiments may be physically combined into more complex blocks, units and/or modules without departing from the scope of the example embodiments.

As discussed previously, many test and measurement instruments, such as network analyzers and spectrum analyzers, allow users to save both raw data and measurement results. However, there is a lack of embedded and automated tools to recognize and process saved image data for further mathematical operations or overlaying with raw data traces. This means there is an untapped opportunity to reuse previously captured images and correlate them with data files to enhance analysis and insights. The inventive concepts described below address this need by providing an automated framework for extracting and processing measurement data from images. By leveraging large language models (LLMs), this framework not only simplifies image processing commands but also enhances context retrieval from the results, making it easier to use and deploy.

As will be apparent, the inventive concepts offer a number of technological advantages over currently available solutions, including automated grid detection which eliminates the need for manual grid detection for every new image. In addition, at least some embodiment are tailored specifically to RF measurements such as s-parameters and spectrum traces, enhanced by LLM-provided context. Further, embodiments herein offer mechanisms to efficiently identify and extract multiple traces from a single image. Separately, accurate unit identification is ensured based on the image header readout, reducing the need for manual recalculations. The embodiments provide a unified and automated environment for data retrieval and post-analysis studies. Seamless correlation is realized in the sense that the automation framework allows one to automatically plot newly converted traces and compare them with previous raw measurement data using single analytics engine. In addition, embodiments of the inventive concepts utilize LLM frameworks to simplify complex image processing commands, also allowing flexibility in choosing image recognition engines. Finally, reduced engineer effort since embodiments of the inventive concepts minimize the high input traditionally required from engineers to accurately find grid coordinates and analyze potential errors.

The framework may be used with a single Path Wave® Test Automation KS8400B toolset (offered by Keysight® Technologies) to replicate all the main workflows stages and steps within one environment. The Path Wave® toolset, which leverages the OpenTap® open source test automation sequencing engine, allows for a streamlined and efficient process of optimizing test sequences in automated test instruments. However, the inventive concepts are not limited to this exemplary toolset.

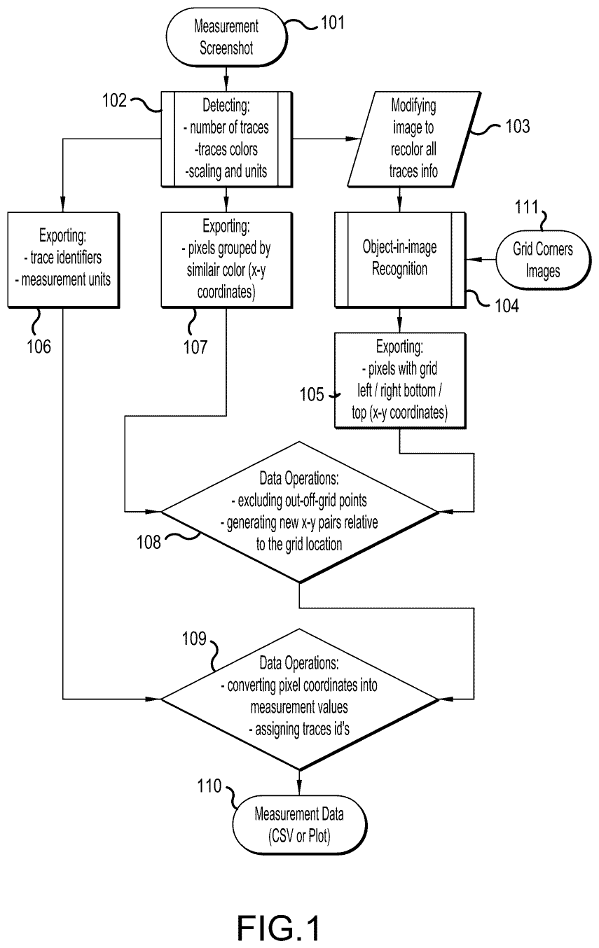

FIG. 1 illustrates a flowchart for reference in describing the construction and operation of automated image analysis system according to embodiments of the inventive concepts.

In particular, FIG. 1 illustrates an automated image analysis process for extracting measurement data from graphical representations according to example embodiments of the inventive concepts. As shown, the process may begin with a measurement screenshot input at step 101. In some aspects, the measurement screenshot may be obtained from a radio frequency (RF) measurement instrument such as a network analyzer or spectrum analyzer.

In step 102, the system detects various attributes of the screenshot, including the number of traces, trace colors, scaling information, and measurement units. This detection step may utilize image recognition techniques to identify and categorize different elements within the screenshot. In some embodiments, the system employs machine learning algorithms or large language models (LLMs) to enhance the accuracy of attribute detection.

Following the initial detection, the process branches into multiple parallel operations. In step 103, the image may be modified to recolor all traces and their associated information. This recoloring step may serve to simplify subsequent detection and analysis processes. By adjusting the color scheme of the traces, the system may enhance contrast and reduce potential interference from background elements or overlapping traces.

The recoloring process may involve assigning distinct colors to each identified trace, ensuring clear differentiation between multiple traces present in the screenshot. In some implementations, the system may utilize a predefined color palette optimized for trace visibility and distinction. Alternatively, the color assignment may be dynamically generated based on the specific characteristics of the input image and the number of traces detected.

Simultaneously with the recoloring step, the system may perform additional operations to extract and categorize information from the screenshot. In step 106, trace identifiers and measurement units are exported. This step may involve isolating and interpreting text elements within the image that correspond to trace labels, axis labels, and unit indicators. The exported information may be crucial for accurately interpreting and converting the graphical data into structured measurement data.

Concurrently, in step 107, the system may export pixels grouped by similar color along with their corresponding x-y coordinates. This pixel grouping process may leverage the recoloring performed in step 103 to efficiently identify and isolate individual traces within the image. By associating pixel groups with specific colors, the system creates a mapping between pixel locations and trace identities, facilitating subsequent data extraction and analysis steps.

The parallel execution of these steps-image modification, trace identifier export, and pixel grouping—may enable efficient processing of complex measurement screenshots containing multiple traces and diverse information elements. This approach may allow the system to handle a wide range of graphical representations from various RF measurement instruments while maintaining accuracy and flexibility in data extraction.

Still referring to FIG. 1, at step 104 an image recognition module operates to find an object in the image. The algorithm uses image recognition techniques to identify objects within the image, particularly focusing on grid corners. Grid Corners Images 111 are once created for a specific application (Network Analyzer or spectrum analyzer X-apps) and its color scheme (dark, light or user-specific) and then reused for multiple detections.

At step 105, the coordinates of the grid corners are exported. These coordinates are used to delete all pixel coordinates outside the grid and also to locate the coordinates based on the scaling factors.

At step 108, data operations are carried out to exclude off-grid points. That is, the algorithm performs data operations to exclude any points that are outside the grid, and then it generates new x-y pairs relative to the grid location which will allow the accurate conversion.

At step 109, further data operations are carried out to convert pixel coordinates. Here, the pixel coordinates are converted into measurement values, and trace IDs (measurement names) are assigned. This step translates the visual data into usable text measurement data.

Finally, at step 110, an output module outputs the processed measurement data in either CSV format or as a plot in measurement analytics software. This data can be used for further analysis and comparison.

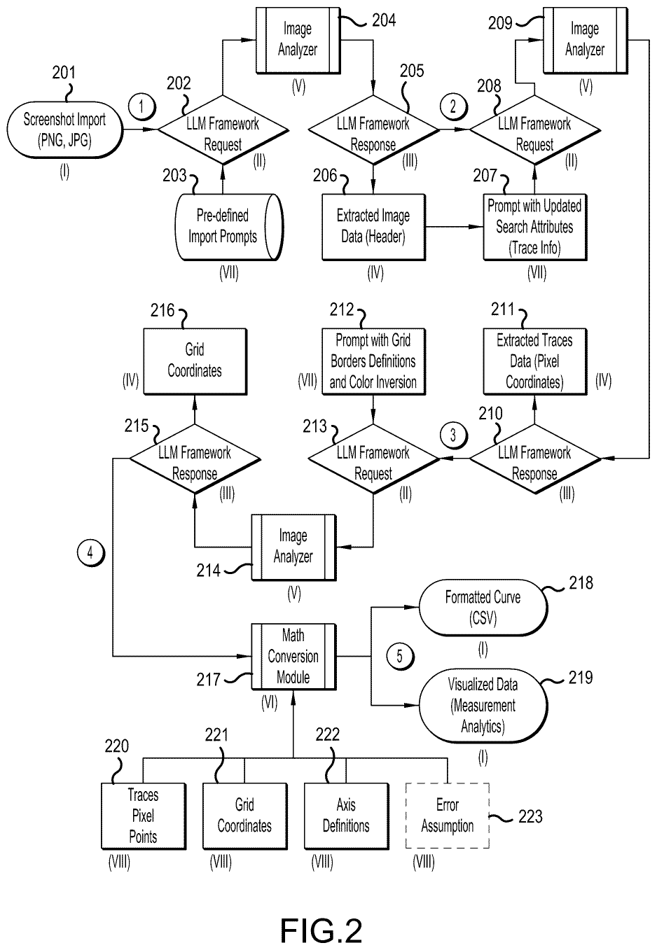

FIG. 2 illustrates a hybrid flowchart and system diagram for reference in describing the construction and operation of automated image analysis system according to embodiments of the inventive concepts. The embodiment of FIG. 2 highlights the practical implementation using an LLM framework.

The circled numbers 1-5 in FIG. 2 denotes process steps of the process (where each process step may include multiple sub-steps). Further, each of the elements illustrated in FIG. 2 includes an adjacent Roman numeral which categorize the elements as described in Table 1 below:

TABLE 1

| Number | Elements | Meaning |
|---|---|---|
| (I) | Data | Represents input or output files or data representations. This |
| | Input/Output | color is used for elements like screenshots, measurement data |
| | Elements | (CSV or plot), or any visual or data files displayed in |
| | | analytics engine. |
| (II) | LLM API | Indicates all interactions with the LLM framework via API |
| | Interactions | calls. This color is used for the steps where the system sends |
| | | requests to the LLM, including prompts for image |
| | | processing, data extraction, or grid definition. |
| (III) | User-Visible | Represents the LLM responses that are shown to the user. |
| | LLM | This color is used for outputs from the LLM that require the |
| | Outputs | user's attention or decision-making, such as extracted image |
| | | data or trace information. |
| (IV) | LLM- | Used to mark all content generated from LLM responses, |
| | generated | either with or without user confirmation. These are typically |
| | Content | intermediary results like grid coordinates, pixel data, or |
| | | extracted traces that are produced by the system after |
| | | processing the LLM's responses. |
| (V) | Image | Represents interactions with the Image Analyzer, which |
| | Processing | could be a part of the LLM deployment. This includes steps |
| | Operations | where the system analyzes the image based on the LLM's |
| | | instructions, such as detecting traces, modifying the image |
| | | color, or searching for grid borders. |
| (VI) | Mathematical | Indicates interactions with math functions, typically |
| | Processing | connected as MATLAB API calls. This color is used for |
| | Functions | operations like data conversion, excluding grid borders or |
| | | performing additional mathematical transformation on the |
| | | extracted data. |
| (VII) | Specific | Indicates specific predefined prompts sent to the LLM. These |
| | Prompts Sent | user prompts are needed for extracting image data, |
| | to LLM | identifying grid coordinates, or processing trace information. |
| | | They are written in natural language and no programming |
| | | code is being used. |
| (VIII) | Data Points | Indicates the data points that are prepared for mathematical |
| | for Math | processing. This color is used for elements like trace pixel |
| | Processing | points, grid coordinates, and axis definitions. Error |
| | | assumption can be sent for typical accuracy calculation if the |
| | | models was pretrained on previous conversion comparison |
| | | with recorded raw data. |

In the practical implementation represented by FIG. 2, there is an increased number of Image Analyzer calls compared to the previous general process of FIG. 1. This difference is due to an extra step circle-2 required for additional user confirmation, ensuring that the image header is recognized correctly. This step could be skipped when the imported images are related to similar measurements within the same instrument and trace definitions.

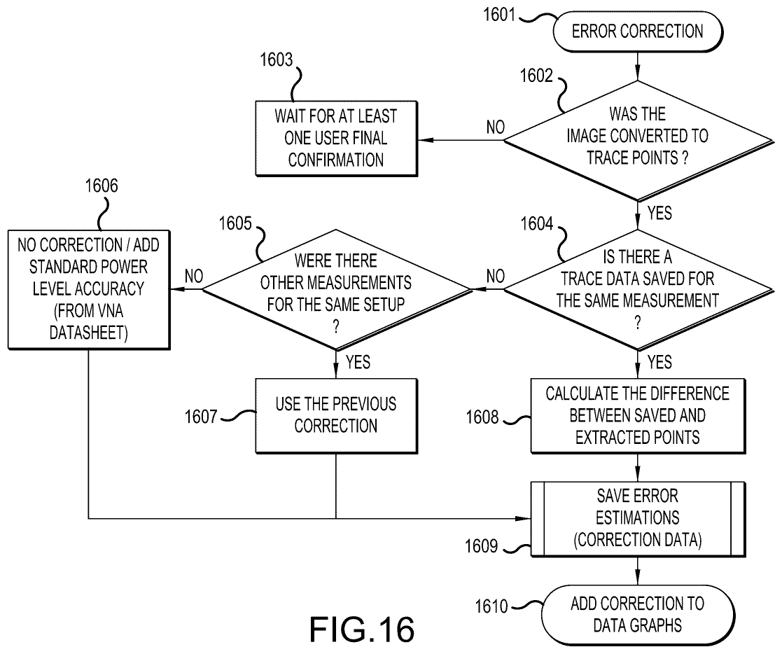

Additionally, the provided scheme includes a potential error assumption process. This error calculation is conducted when there is matching raw data saved by the user along with the instrument screenshot for the same measurement. The mismatch between the extracted data and the raw data can then be used to determine typical accuracy for similar image series and plotted in analytics toolsets. An error correction process is described in greater detail later in connection with FIG. 16.

### Process Step Circle-1

Referring to FIG. 2, at 101, a Screenshot Import takes place. That is, the process begins with the import of a measurement screenshot (e.g., in PNG or JPG format). This serves as the primary input for the subsequent analysis.

Next, at 202, LLM Framework Request occurs. Here, a pre-defined import prompt 203 is sent to the LLM framework, initiating the analysis of the imported image. The LLM processes the image, focusing on extracting metadata such as the image header, which is dictated by the prompts.

Next, at 204, the Image Analyzer processes the image based on low-level instructions received from the LLM framework. Here, the image analyzer extracts all the text data for the image, including details like trace identifiers and measurement units.

### Process Step Circle-2

Next, at 205 and 206, there is an LLM framework response. Here, the extracted image header data is returned by the LLM framework and displayed to the user. This data includes information such as the number of traces, their identifiers, and the units of measurement—this recognition of the specific header context is available only with LLM specific capabilities to process text data.

Next, at 207 and 208, Based on the extracted header data, an updated prompt is generated and sent to the LLM framework. This prompt includes more specific search attributes, such as trace information and grid details.

### 1. Next, at 208 and 209, Further Image Analysis:

The Image Analyzer conducts a more detailed analysis of the image, focusing on the specific trace attributes provided. This step involves extracting trace data, including pixel coordinates and trace identifiers.

### Process Step Circle-3

Next, at 211 and 210, a grid coordinates and trace data extraction is carried out. Namely, the system extracts grid coordinates from the image. These coordinates are critical for accurately mapping the trace data, especially when multiple traces are present.

Next, at 212 and 213, grid borders and color inversion takes place. That it, process then prompts the LLM framework to define the grid borders and apply color inversion to enhance the visibility and accuracy of the extracted data.

### Process Step Circle-4

Next, at 214, 215 and 216, the LLM framework processes the prompt and sends back instructions to the Image Analyzer. The Image Analyzer first modifies the image to exclude interfering trace pixels of different colors, ensuring that only the relevant data is analyzed. Following this, the Image Analyzer identifies and locates the typical pre-stored grid corners within the image and returns these corner coordinates for further processing. The Image Analyzer outputs pixel data with found grid definitions, which are necessary for further mathematical processing and deleting out-of-grid points.

At 217, a math conversion module processes the pixel data, converting coordinates into measurement values. This module also excludes any off-grid points and assigns trace IDs to the data.

At 220 through 223, an error assumption process is carried out. That is, if matching raw data is available for the same measurement series, the system triggers an error assumption process. This step adds typical accuracy values which were calculated by comparison of extracted data with stored and proven raw data.

The process steps associated with each of the circled numbers in FIG. 2 are discussed next.

### Process Step Circle-5

Lastly, at 218 and 219, a final data output process takes place. Here, the process ends with generating the final output artifacts, which include a formatted curve in CSV format and database inputs for measurement analytics software.

User interactions within the LLM framework are discussed next.

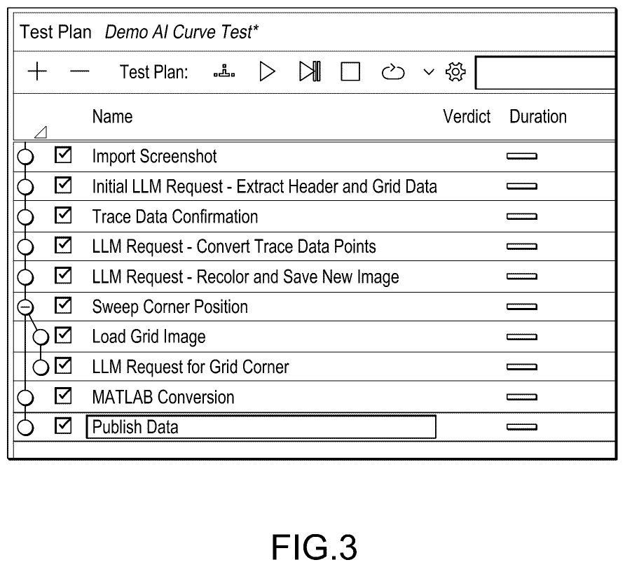

Referring to FIG. 3, a Test Plan interface for implementing the automated image analysis process within an OpenTAP® sequencer framework is shown. The interface may display a series of sequential steps that represent the workflow for analyzing and extracting data from measurement screenshots.

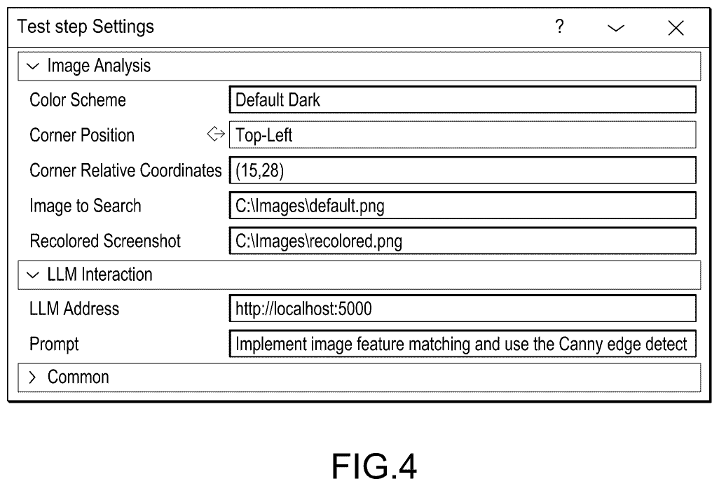

In the illustrated example, the Test Plan may be organized as a Demo AI Curve Test, with each step of the process represented by a checkbox and a descriptive name. Steps shown in FIG. 3 are grouped and executed in accordance with the FIG. 1 and FIG. 2. FIG. 4 illustrates an example of particular test step settings which retrieves relative grid coordinates:

Referring to FIG. 3, athe Test Plan may begin with an “Import Screenshot” step, which may involve receiving the measurement screenshot into the system. This step may correspond to the image input module described earlier, allowing the framework to accept various image formats such as PNG or JPG files.

Following the import step, the Test Plan may include an “Initial LLM Request-Extract Header and Grid Data” step. This step may utilize a large language model (LLM) to analyze the imported image and extract key information such as header details and grid data. The use of an LLM at this stage may enhance the system's ability to accurately interpret complex measurement screenshots.

A “Trace Data Confirmation” step may be included in the Test Plan. This step may allow for verification of the extracted trace data, potentially improving the overall accuracy of the analysis process. In some cases, this step may involve user interaction to confirm or adjust the automatically extracted information.

The Test Plan may then proceed with an “LLM Request-Convert Trace Data Points” step. This step may correspond to the data processing module, where pixel coordinates are converted to measurement values based on the detected header information and grid coordinates.

An “LLM Request-Recolor and Save New Image” step may be incorporated into the Test Plan. This step may involve modifying the original screenshot to enhance visibility or simplify subsequent analysis steps. The recoloring process may be guided by LLM-generated instructions tailored to the specific characteristics of the measurement data.

The Test Plan may include a “Sweep Corner Position” step, which may involve identifying or adjusting the corner positions of the measurement grid. This step may be crucial for accurately mapping pixel coordinates to measurement values.

A “Load Grid Image” step may be present in the Test Plan. This step may involve loading a reference grid image, which may be used for comparison or alignment purposes during the analysis process.

The Test Plan may feature an “LLM Request for Grid Corner” step. This step may utilize the LLM to precisely identify or confirm the grid corners in the image, potentially improving the accuracy of subsequent coordinate conversions.

A “MATLAB Conversion” step may be included in the Test Plan. This step may involve using MATLAB or a similar computational tool to perform numerical conversions or calculations on the extracted data. The integration of MATLAB within the OpenTAP framework may allow for complex mathematical operations to be seamlessly incorporated into the analysis workflow.

The final step in the Test Plan may be “Publish Data,” which may correspond to the output module of the system. This step may involve generating formatted measurement data based on the processed and error-corrected values.

In some aspects, the OpenTAP sequencer framework may provide controls for adding, removing, and managing test plan steps. This flexibility may allow users to customize the analysis workflow for specific measurement types or instrument outputs.

The OpenTAP sequencer may also offer options for running, pausing, and configuring the test plan. These features may enable users to control the execution of the analysis process, potentially allowing for real-time adjustments or interventions if needed.

By implementing the automated image analysis process within an OpenTAP sequencer framework, the system may provide a structured, repeatable, and customizable approach to extracting and processing measurement data from screenshots. This integration may enhance the efficiency and reliability of the analysis process across various measurement scenarios and instrument types.

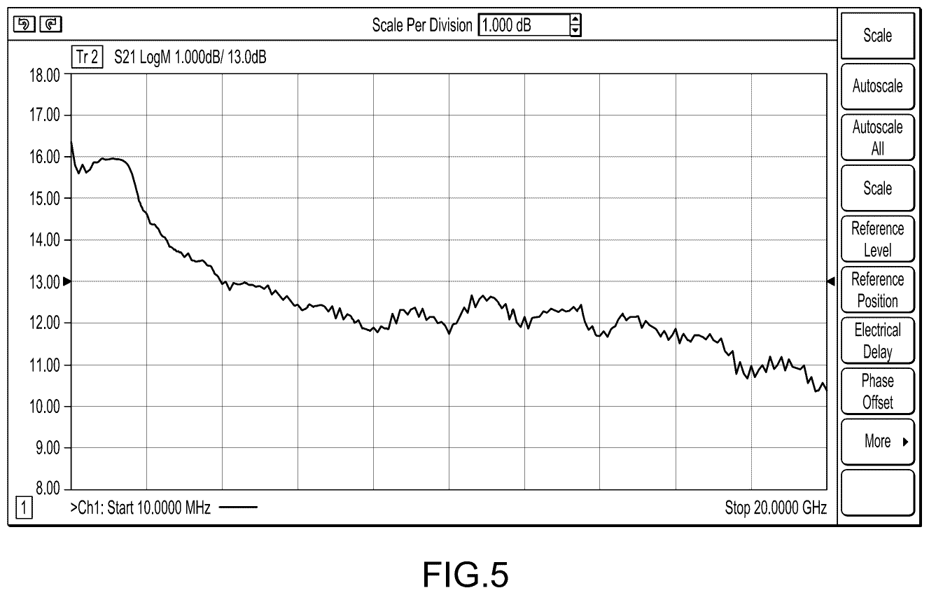

Referring to FIG. 5, a screenshot of a network analyzer display showing a frequency response measurement is illustrated. The display may feature a graph with a dark background and a light blue trace representing the measured signal. In some aspects, the vertical axis may show amplitude in decibels, ranging from 8 to 18 dB, while the horizontal axis may represent frequency. A grid overlay may aid in reading the graph values. The trace may show a general downward trend with some fluctuations.

The automated image analysis framework may be specifically designed to process and analyze such RF measurement screenshots. In some cases, the framework may identify and extract key elements from the display, including the trace color, axis labels, and scaling information. The system may recognize the light blue color of the trace and associate it with a specific measurement parameter, such as S21 in this example.

The framework may be capable of interpreting the axis labels and units. For the vertical axis, the system may detect the decibel (dB) scale and the range from 8 to 18 dB. On the horizontal axis, the framework may identify the frequency scale, which may typically range from MHz to GHz in RF measurements. This specialized support for RF and millimeter-wave measurements may allow the system to accurately convert pixel coordinates to meaningful measurement values.

In some implementations, the framework may also process the grid overlay, using it as reference points for precise data extraction. The system may detect the grid lines and use them to calibrate the pixel-to-value conversion, ensuring accurate representation of the measurement data.

On the right side of the display, a control panel with various buttons for adjusting display settings may be present. The automated analysis framework may be capable of recognizing these control elements and extracting relevant information about the measurement setup. This may include details such as scale settings, reference levels, and other parameters that could affect the interpretation of the trace data.

The framework's ability to process vector network analyzer (VNA) traces may extend beyond simple amplitude measurements. In some cases, the system may be capable of handling complex S-parameter data, including magnitude and phase information. This specialized support for RF measurements may allow the framework to accurately extract and represent a wide range of measurement types commonly encountered in RF and microwave engineering.

By leveraging its understanding of RF measurement conventions and VNA display formats, the automated image analysis framework may provide more accurate and context-aware data extraction compared to general-purpose image processing tools. This specialized capability may be particularly valuable in RF engineering workflows, where precise interpretation of measurement data is critical for design and analysis tasks.

As noted above, FIG. 4 “LLM Request for Grid Corner” Test Step Settings. Below is an example of the user-machine interactions marked by numbers in the FIG. 2. within following test setup and measurement type:

| | |
|---|---|
| Instrument | Network Vector Analyzer PNA-L N5235A |
| Traces | Scalar Trace 2, S21 |
| Measurement | S-parameters, Gain |
| Measured | Power Amplifier |
| Device | |
| Screenshot | PNG, |
| Format | |
| Color Scheme | Standard Dark |
| LLM | Keysight/Microsoft Azure/Copilot |
| Deployment | |
| Image Analyzer | Embedded into Copilot |

The user interactions in the process of FIG. 2 are described in greater detail next. The descriptions is segregated into five (5) sections, namely “Screenshot Import”, “LLM Framework Response after Initial Image Analysis”, “LLM Framework Response with Trace Data Points”, “Grid Extraction and Math Operation” and “Final Data Conversion Outputs.”

### 1. Screenshot Import

The user begins by importing a screenshot in PNG or JPG format into the system. This image serves as the primary input for the analysis. FIG. 5 illustrates a screenshot example captured by a VNA (Vector Network Analyzer) standard interface.

Below in italics is the predetermined prompt which the OpenTAP sequencer then sends to the LLM via an API call:
“Process the image from the network analyzer S-parameters measurements. Extract key metadata values focusing on the:
Trace Colors
Trace Names
Trace Index
Axis Names
Axis Units
Axis Scales
Color Scheme
   Also generate a table having columns with position (top-left, top-right, bottom-left and bottom-right) and x-y scales readouts (based on min-max scales).”
      2. LLM Framework Response after Initial Image Analysis

After the user imported a PNG-file which was accompanied with a request to the LLM framework using pre-defined import prompts, the framework shows the preliminary header instruction results. This is an extra step needed to ensure trace info was analyzed correctly and the next furthermore complex and time-consuming data extraction process will use correct initial conditions. This step could be skipped for batch images processing when the headers/data are similar.

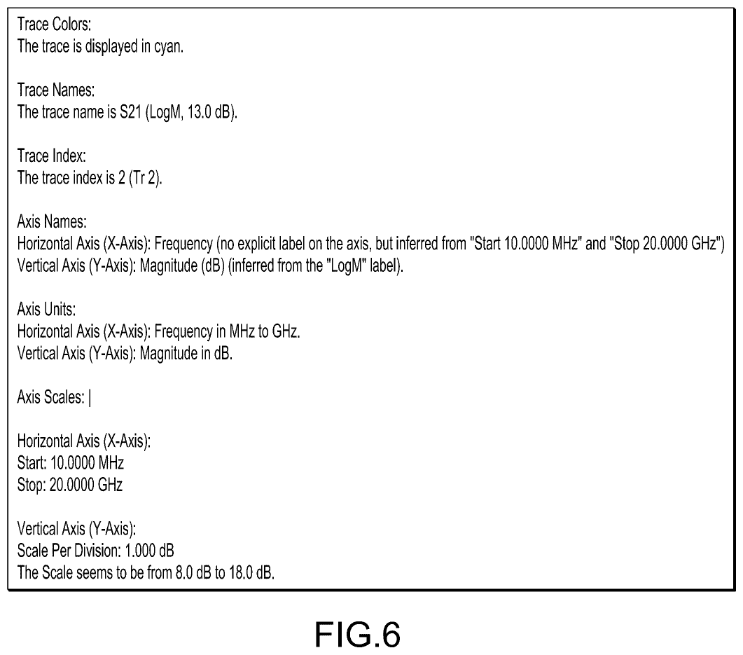

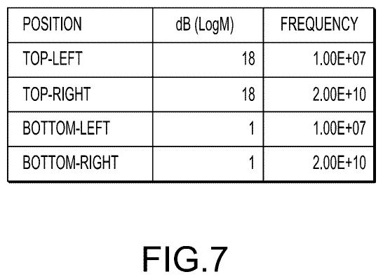

The LLM response after it analyzed data from embedded Image Analyzer call could look the response illustrated in FIGS. 6 and 7. That is, FIG. 6 shows an LLM-response capture from the API call, and FIG. 7 shows the LLM-response with grid definitions in physical units.

User confirms this output and then a new request to LLM is created in order to further analyze the image details. This request is constructed of a predefined prompt and recently acquired image header definitions (color variability is added due to potential color mismatch when the image is compressed, the best results are):
“Create a table with all pixel coordinates for trace definitions below (x-y pairs, ascending from x):
[extracted trace colors/names/index]
Use a variety of colors with the similar shade, applying close RGB values. The table should have columns with RGB codes, X, Y.”
   3. LLM Framework Response with Trace Data Points

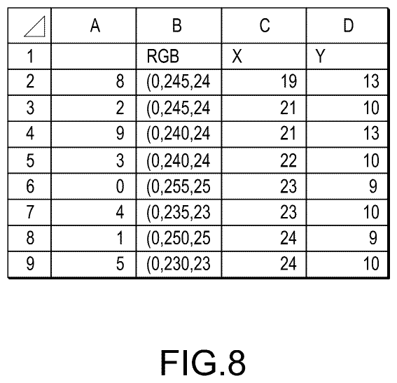

After receiving specific search attributes based on the extracted trace data the user receives a formatted table with a system raw identifier, RGB codes and x-y coordinates for each trace, as shown in the exported trace table (2 pixels) of FIG. 8. This table is saved through OpenTAP Test Step for further analysis

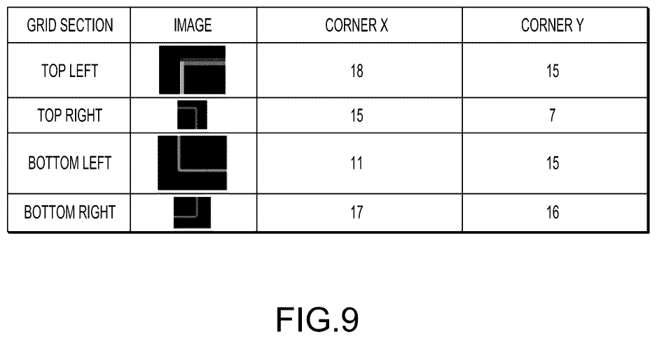

The important part of this step is supplying the Image Analyzer with the grid corners as images to find within the original image. These corners are once created by the user for each color scheme and stored in the database. Referring to the table of FIG. 9, every image also has an exact coordinate marked by the user showing the grid corner as a metadata parameter.

Before finding the grid images within the original image it might be useful to exclude +++++++++ trace points from the original image so as not to interfere with each other and grid lines. This may be done by a service prompt sent in advance (user intervention is not needed, works better for light color scheme). An example of the service prompt is shown below.
“All previously exported pixel points with their coordinates specified in the table should both have the different color matching the background of the original screenshot. Use this picture for further analysis.”

Then OpenTAP® test step makes an API call to send this image with grid corner coordinates specified for each of them to the LLM with a prompt such as the following:
“Implement image feature matching and use the Canny edge detection algorithm to find edges in attached small corner image and recolored measurement screenshot. Then try to match those features. I am sending you the small image to be found within the big image. Once you've found top-left and bottom-right corners of the matching region taking into account the pixel of interest in the small image had coordinates [15, 28] calculate where the position of this pixel in the larger image would be.”

### 4. Grid Extraction and Math Operation

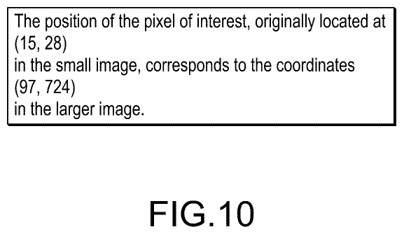

OpenTAP® summarize the 4 sequential responses of LLM into a table with grid definitions in.csv-format. Example LLM-responses are shown in FIGS. 9 and 10. That is, FIG. 9 illustrates an LLM-response after a top left corner recognition procedure, and FIG. 10 is an example of a table created by OpenTAP, summarizing corner_position]−[coordinates] from the initial call.

Note, that there is a redundancy in the corner definitions (taking 4 positions instead of minimum 2 needed for a rectangular grid, which can be detailed even further) in order to increase accuracy of following math operations.

### Math Calculations Functions May Include:

Averaging Grid Coordinates (Rectangular Grid): This step calculates the grid layout, which should have a rectangular shape (averaging Top-Bottom Y and Left-Right X coordinates)
Grid Conversion: In this step a direct conversion of a pixel-defined grid into previously exported grid with physical unit-definition is happening.
Out-of-Grid Points Removal in the Trace Data: This function excludes any data points that fall outside the defined grid area from the trace data.
Conversion of Pixels into S-Parameter/Frequency Values Based on Scaling Info: This step involves converting the pixel coordinates of the trace data into meaningful S-parameter and frequency values, using the scaling information derived from the image header and grid.
Additional Error Correction (If Available for Current Layout): If error data is available for the current layout, this function saves additional accuracy data in the final. csv-result or analytics database input.

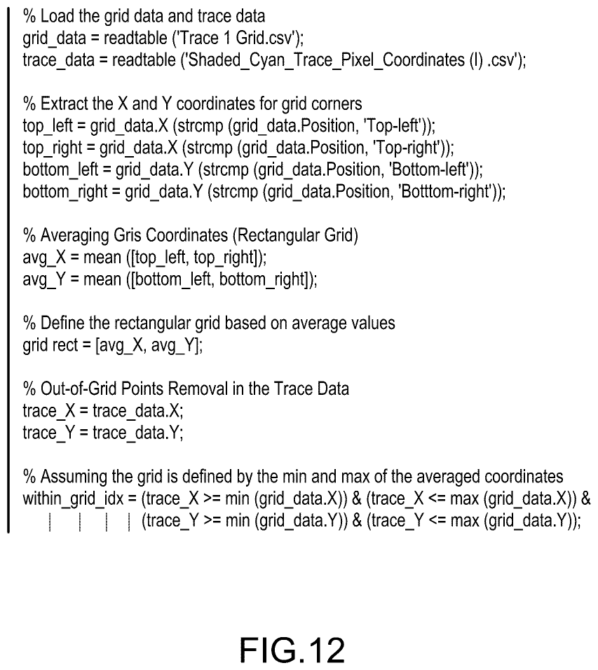

Math Calculations may be run using MATLAB-code API call and related Open-TAP Plugin as shown in FIG. 12.

Referring to FIG. 12, a code snippet for processing grid and trace data in an automated image analysis system is shown. The code snippet may illustrate key components of the data processing module, which may be configured to convert pixel coordinates to measurement values for multiple detected traces within a measurement screenshot.

In some aspects, the code may begin by loading grid data and trace data from CSV files. This step may involve importing previously extracted information about the grid structure and raw pixel coordinates of detected traces. The system may then extract X and Y coordinates for grid corners, including top-left, top-right, bottom-left, and bottom-right positions. These corner coordinates may be crucial for defining the measurement area within the screenshot.

The code may include functions to remove out-of-grid points from the trace data. In some implementations, the system may assume the grid is defined by the minimum and maximum values of the averaged corner coordinates. This approach may allow for flexible handling of slight variations in grid alignment or perspective distortions in the screenshot.

When converting pixel coordinates to measurement values, the system may exclude pixel coordinates that fall outside the detected grid coordinates. This step may help ensure that only relevant data points within the defined measurement area are processed, potentially improving the accuracy of the final output.

### 5. Final Data Conversion Outputs

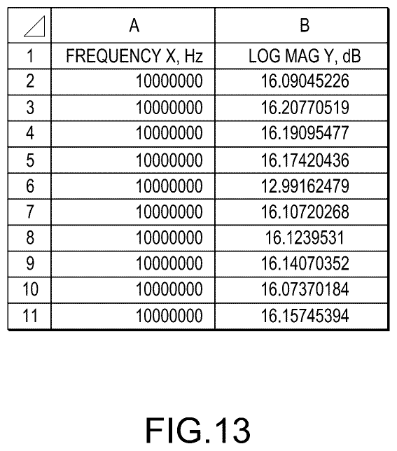

Finally, the user receives the data containing converted trace data points in .csv-format. An example of this is shown the converted S21 trace data table of FIG. 13.

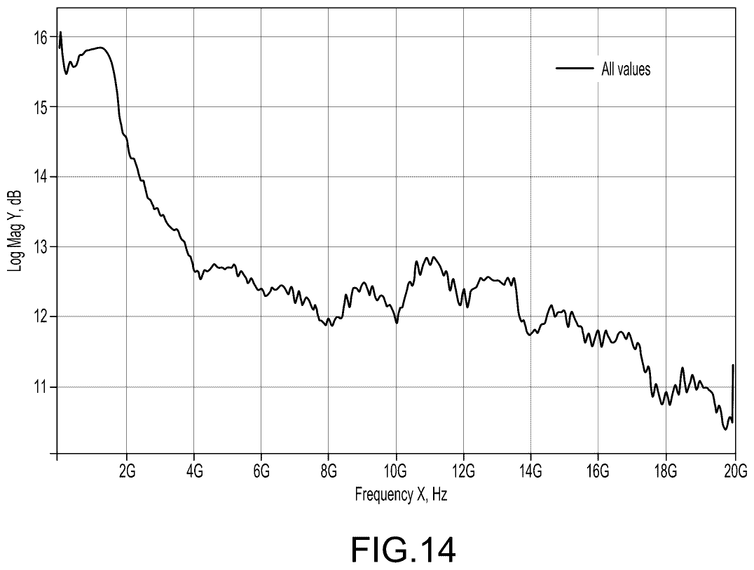

Additionally, while the data is being published into .csv it can also be sent to Path Wave Measurement Analytics database for a visualization using embedded OpenTAP Result Listener and existing Keysight KS6800A toolset. An example of this is shown in the Pathwave Measurement Analytics Trace Import shown in FIG. 14.

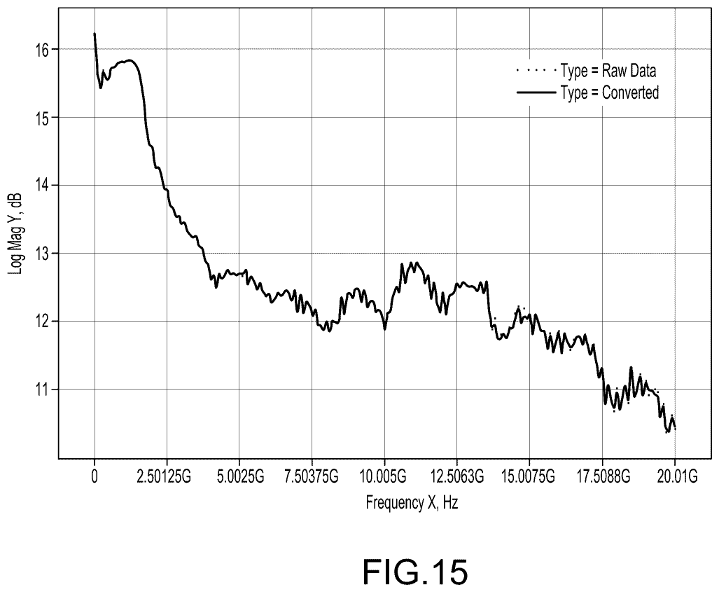

After that all new traces analyzed within this framework can be easily overlayed with each other using this Path Wave Measurement Analytics toolset so that the screenshot image data is summarized within one measurement-grade toolset. FIG. 15 illustrates an example of when recognized trace data is plotted over raw data for the same measurement (saved as .csv by the instrument). One can also notice the accuracy of the conversion methodology implemented.

An error correction process according to embodiments of the inventive concepts will now be described.

Unlike simpler extractors, the framework of the inventive concepts includes mechanisms to estimate error values in the extracted data, adding a layer of accuracy that is especially valuable in measurement applications where data precision is critical.

FIG. 16 is a flowchart for reference in describing a step-by-step breakdown of the error correction process.

Referring to FIG. 16, the process begins (at 1601) by waiting for user confirmation to proceed with error correction. Upon confirmation, a conversion check (at 1602) is then performed in which the system verifies if the image has been successfully converted into trace points. If not (NO at 1602), it loops back (at 1603) to await further user confirmation. If the trace points are available (YES at 1602 (e.g., the measurement was also saved as a text-file or .s2p file), the system checks (at 1604) for previously saved trace data for the same measurement setup.

If the previous trace data exists (YES at 1604), the system calculates (at 1608) the difference between saved data points and the newly extracted trace points, using this difference to determine error estimates. On the other hand, if no previous trace data exists (NO at 1604), the system (at 1605) determines whether other measurements are available for the same setup. If so (YES at 1605), previous corrections are used (at 1607). That is, for repeat measurements of the same setup, the system can automatically apply the previously saved correction data, streamlining the error correction process. If no other measurements are available for the same setup (NO at 1605), the system applies (at 1606) standard power level accuracy from the VNA's datasheet as the baseline (can be added to the VNA Traces library).

Once error estimates are confirmed, they are applied (at 1610) to the extracted data points (using the margins feature of Measurement Analytics or added as separate data columns), with the final corrected data then embedded in the output data graphs.

In addition to error correction, the inventive concepts offer other unique features. Some of those features have been discussed previously. Some of these features are highlighted below.

The inventive concepts are built to support RF/mm-wave measurement traces, targeting VNAs, through a library that recognizes parameter types, colors, grid corners, and header sections. This setup reduces the need for manual intervention and is particularly suited for applications where RF data and s-parameters are involved:
Trace Types: Supports critical VNA trace types, including S-parameters (S11, S21, S12, S22), impedance, return loss, and phase response. Each trace type is identified and mapped by analyzing specific color, pattern, and scale markers.
Header Parsing: The system parses essential VNA headers, such as frequency range, sweep type (linear, log), power level, and reference plane information. This includes interpreting X-axis (frequency) and Y-axis (dB or phase) unit headers, ensuring accuracy across different measurement setups.
Automated Grid Calibration: Detects grid markers specific to VNA data, recalibrating pixel data to match typical frequency and dB scales, even on complex multi-trace displays

Separately, the inventive concepts allow for the incorporation of all extracted information as vectorized data, which is then fine-tuned within an LLM framework. This tuning enables the system to better recognize and interpret specific graphical elements relevant to RF and measurement data, making it adaptable to different use cases and instruments.

Further, the inventive concepts provide a single environment for both extracting, converting and plotting data. Users can convert graphical data to tabular form and overlay new data points for visual correlation studies without switching tools. This integrated setup reduces effort and errors, enhancing productivity.

Also, unlike general-purpose tools, the inventive concepts facilitate specialized handling of multiple traces with complex scaling and unit conversions.

The inventive concepts encompass systems and methods for optimizing test sequences in automated test systems as described above. Further, the inventive concepts encompass non-transitory computer readable storage media having instructions stored therein that when executed by a processor cause the processor to carry out the methods of the inventive concepts. The memory storing the instructions can comprise random access memory (RAM), read only memory (ROM), optical read/write memory, cache memory, magnetic read/write memory, flash memory, and/or any other non-transitory computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. While representative embodiments are disclosed herein, one of ordinary skill in the art will appreciate that many variations that are in accordance with the present teachings are possible and remain within the scope of the appended claim set. The invention therefore is not to be restricted except within the scope of the appended claims.

What is claimed is:

1. A system for automated image analysis and data extraction, comprising:
an image input module configured to receive a measurement screenshot;
an image recognition module configured to detect header information, trace identifiers, and grid coordinates from the measurement screenshot;
a data processing module configured to convert pixel coordinates to measurement values based on the detected header information and grid coordinates;
an error correction module configured to calculate and apply error estimates to the converted measurement values; and
an output module configured to generate formatted measurement data based on the error-corrected converted measurement values.

2. The system of claim 1, wherein the image recognition module is further configured to detect multiple traces within the measurement screenshot.

3. The system of claim 2, wherein the data processing module is further configured to convert pixel coordinates to measurement values for each of the multiple detected traces.

4. The system of claim 1, wherein the image recognition module utilizes a large language model (LLM) for detecting header information, trace identifiers, and grid coordinates.

5. The system of claim 4, wherein the LLM is fine-tuned for recognizing specific graphical elements relevant to RF and measurement data.

6. The system of claim 1, wherein the error correction module is configured to calculate error estimates based on comparison with previously saved trace data for the same measurement setup.

7. The system of claim 6, wherein the error correction module is further configured to apply standard power level accuracy from a vector network analyzer datasheet when no previously saved trace data is available.

8. A method for automated image analysis and data extraction, comprising:
receiving a measurement screenshot;
detecting, using image recognition techniques, header information, trace identifiers, and grid coordinates from the measurement screenshot;
converting pixel coordinates to measurement values based on the detected header information and grid coordinates;
calculating and applying error estimates to the converted measurement values; and
generating formatted measurement data based on the error-corrected converted measurement values.

9. The method of claim 8, wherein detecting header information, trace identifiers, and grid coordinates comprises utilizing a large language model (LLM) fine-tuned for recognizing specific graphical elements relevant to RF and measurement data.

10. The method of claim 9, further comprising modifying the measurement screenshot by recoloring traces and their associated information prior to detecting header information, trace identifiers, and grid coordinates.

11. The method of claim 10, wherein converting pixel coordinates to measurement values comprises:
excluding pixel coordinates that fall outside the detected grid coordinates; and
generating new coordinate pairs relative to the grid location.

12. The method of claim 11, further comprising assigning trace identifiers to the converted measurement values based on the detected trace identifiers.

13. The method of claim 12, wherein calculating error estimates comprises comparing the converted measurement values to previously saved trace data for the same measurement setup.

14. The method of claim 13, wherein generating formatted measurement data comprises outputting the error-corrected converted measurement values in a CSV format and as a plot in measurement analytics software.

15. A non-transitory computer-readable medium storing instructions that, when executed by a processor, cause the processor to perform operations for automated image analysis and data extraction, the operations comprising:
receiving a measurement screenshot;
detecting, using image recognition techniques, header information, trace identifiers, and grid coordinates from the measurement screenshot;
converting pixel coordinates to measurement values based on the detected header information and grid coordinates;
calculating and applying error estimates to the converted measurement values; and
generating formatted measurement data based on the error-corrected converted measurement values.

16. The non-transitory computer-readable medium of claim 15, wherein detecting header information, trace identifiers, and grid coordinates comprises utilizing a large language model (LLM) fine-tuned for recognizing specific graphical elements relevant to RF and measurement data.

17. The non-transitory computer-readable medium of claim 16, wherein the operations further comprise modifying the measurement screenshot by recoloring traces and their associated information prior to detecting header information, trace identifiers, and grid coordinates.

18. The non-transitory computer-readable medium of claim 17, wherein converting pixel coordinates to measurement values comprises:
excluding pixel coordinates that fall outside the detected grid coordinates; and
generating new coordinate pairs relative to the grid location.

19. The non-transitory computer-readable medium of claim 18, wherein the operations further comprise assigning trace identifiers to the converted measurement values based on the detected trace identifiers.

20. The non-transitory computer-readable medium of claim 19, wherein calculating error estimates comprises comparing the converted measurement values to previously saved trace data for the same measurement setup, and wherein generating formatted measurement data comprises outputting the error-corrected converted measurement values in a CSV format and as a plot in measurement analytics software.
